(19) United States
(12) Patent Application Publication
(10) Pub. No.: US 2023/0196094 A1
(43) Pub. Date: Jun. 22, 2023

(54) QUANTIZATION METHOD FOR NEURAL NETWORK MODEL AND DEEP LEARNING ACCELERATOR

(71) Applicant: INDUSTRIAL TECHNOLOGY RESEARCH INSTITUTE, Hsinchu (TW)

(72) Inventors: Chih-Cheng LU, Hsinchu City (TW); Jin-Yu LIN, Taichung City (TW); Kai-Cheung JUANG, Hsinchu City (TW)

(73) Assignee: INDUSTRIAL TECHNOLOGY RESEARCH INSTITUTE, Hsinchu (TW)

(21) Appl. No.: 17/560,010

(22) Filed: Dec. 22, 2021

(51) Int. Cl. G06N 3/08; G06N 3/04

(52) U.S. Cl. CPC G06N 3/08; G06N 3/0481

(57) ABSTRACT

A quantization method for neural network model includes following steps: initializing a weight array of a neural network model, wherein the weight array includes a plurality of initial weights; performing a quantization procedure to generate a quantized weight array according to the weight array, wherein the quantized weight array includes a plurality of quantized weights within a fixed range; performing a training procedure of the neural network model according to the quantized weight array; and determining whether a loss function is convergent in the training procedure and outputting a post-trained quantized weight array when the loss function is convergent.

### TECHNICAL FIELD

The present disclosure relates to a quantization method for a neural network model and a deep learning accelerator.

### BACKGROUND

A deep neural network (DNN) is a very computationally expensive algorithm. In order to smoothly deploy the DNN on edge devices with less computing resources, one has to overcome the performance bottleneck of the DNN computation and reduce the power consumption. Therefore, researches on the compression and acceleration technology of the DNN model have become a primary goal. The compressed DNN model uses fewer weights and thereby improving the computation speed on some hardware devices.

Quantization is an important technique of DNN model compression. Its concept is to change the representation ranges of the activation value and weight value of the DNN model and convert the float-point number into an integer number. The quantization technique may be divided into two methods according to its application timing: Post Training Quantization (PTQ) and Quantization-Aware Training (QAT). PTQ performs the conversion of computation types directly based on a well-trained model, and the intermediate processing does not change the weight value of the original model. An example of QAT is to insert a fake-quantization node in the original architecture of the model, and then use the original training process to implement the quantization model.

However, in the aforementioned QAT example, the quantization architecture such as TensorFlow has to pre-trained a model to quantize and de-quantize the floating-point number. The common quantization method also has several potential problems. Firstly, after the initial weight is quantized, there will be a bias term that requires additional hardware processing. Secondly, since the weight range is not limited, different sizes of quantization intervals for the same initial weight will generate inconsistent quantization results, resulting in unstable quantization training. Therefore, the weight distribution may affect the quantization training, especially at a condition of low quantization bit.

### SUMMARY

According to an embodiment of the present disclosure, a quantized method for a neural network model comprising: initializing a weight array of the neural network model, wherein the weight array comprises a plurality of initial weights; performing a quantization procedure to generate a quantized weight array according to the weight array, wherein the quantized weight array comprises a plurality of quantized weights, and the plurality of quantized weights is within a fixed range; performing a training procedure of the neural network model according to the quantized weight array; and determining whether a loss function is convergent in the training procedure, and outputting a post-trained quantized weight array when the loss function is convergent

According to an embodiment of the present disclosure, a deep learning accelerator comprising: a processing element matrix comprising a plurality of bitlines, wherein each of the plurality of bitlines electrically connects to a plurality of processing elements respectively, each of the plurality of processing elements comprises a memory device and a multiply accumulator, the plurality of memory devices of the plurality of processing elements is configured to store a quantized weight array, the quantized weight array comprise a plurality of quantized weights; the processing element matrix is configured to receive an input vector, and performing a convolution operation to generate an output vector according to the input vector and the quantized weight array; and a readout circuit array electrically connecting to the processing element matrix, and comprising a plurality of bitline readout circuits; the plurality of bitline readout circuits correspond to the plurality of bitlines respectively, each of the plurality of bitline readout circuits comprises an output detector and an output readout circuit, the plurality of output detectors is configured to detect whether an output value of each of the plurality of bitlines is zero, and to disable the output readout circuit whose output value is zero from the plurality of output readout circuits.

### BRIEF DESCRIPTION OF DRAWINGS

FIG. 1 is a flow chart of a quantization method for a neural network model according to an embodiment of the present disclosure;

FIG. 2 is a detailed flow chart of a step in FIG. 1;

FIG. 3 is a schematic diagram of a conversion of the quantization procedure;

FIG. 4 is a flow chart of a weight pruning method for the neural network model according to an embodiment of the present disclosure;

FIG. 5 is a schematic diagram of a tunnel composed of weight bits; and

FIG. 6 is an architecture diagram of a deep learning accelerator according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

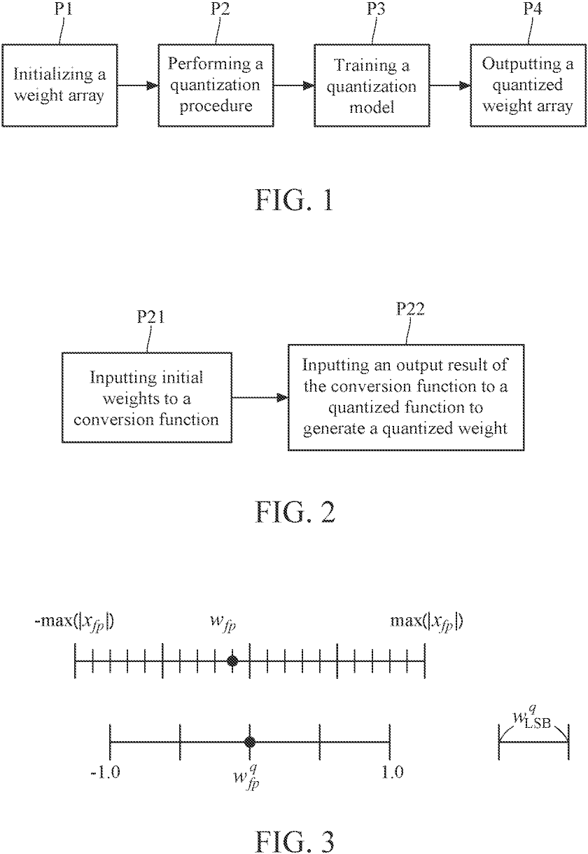

FIG. 1 is a flow chart of a quantization method for a neural network model according to an embodiment of the present disclosure and includes steps P1–P4.

Step P1 represents “initializing a weight array”. In an embodiment, a processor may be adopted to initialize a weight array of a neural network model. The weight array includes a plurality of initial weights and each of the plurality of initial weights is a floating-point number. In practice, values of the plurality of initial weights may be randomly set by the processor.

Step P2 represents “performing a quantization procedure”. In an embodiment, the processor performs a quantization procedure to generate a quantized weight array according to the weight array. The quantized weight array includes a plurality of quantized weights, and the plurality of quantized weights is within a fixed range. FIG. 2 is a detailed flow chart of step P2. Step P21 represents “inputting initial weights to a conversion function”, and step P22 represents “inputting an output result of the conversion function to a quantized function to generate a quantized weight”.

In step P21, the processor inputs every initial weight to the conversion function, so as to convert an initial range of these initial weights into a fixed range. The conversion function includes a nonlinear conversion formula. In an embodiment, the nonlinear conversion formula is a hyperbolic tangent function (tanh), and the fixed range is [-1, +1]. The Equation 1 is an embodiment of the conversion function, where T_{w} denotes as the nonlinear conversion formula, w_{fp} denotes as the initial weight, and

$${{w}^{′}}_{f p}$$

denotes as the output result of conversion function.

$${{w}^{′}}_{f p} ← {T}_{w} \left({w}_{f p}\right)$$

In step P22, the processor inputs the output result of the conversion function to the quantization function to generate a plurality of quantized weights. The Equation 2 is an embodiment of the quantization function, where

$${w}_{f p}^{q}$$

denotes as a quantized weight, the round function is configured to compute a rounding value, and bw is the number of bits of quantization.

$${w}_{f p}^{q} ← 2 ⋅ \frac{r o u n d \left({{w}^{′}}_{f p} ⋅ \left({2}^{{b}_{w}} - 1\right)\right)}{{2}^{{b}_{w}}} - 1$$

FIG. 3 is a schematic diagram of a conversion of the quantization procedure. The quantization procedure converts an initial weight w_{fp} (with high precision and being a floating-point type) into a quantized weight

$${w}_{f p}^{q}$$

(whose precision is lower than that of the former and being a floating-point type), where ±max(|x_{fp}|) denotes as an initial range of the initial weight,

$${w}_{L S B}^{q}$$

denotes as a distance between two adjacent quantized weights. Overall, the quantization procedure is configured to convert every initial weight with a high precision and a floating-point type into to quantized weight with low precision and the floating-point type. No matter what the initial range of the initial weight ±max(|x_{fp}|) is, the outputted value is always within the fixed range [1, -1] after the conversion of the quantization procedure, and thus an operation of zero-point alignment may be neglected, and the hardware design for the bias term can be saved. The quantization procedure proposed by the present disclosure can generate a fixed quantization interval

$${w}_{L S B}^{q}$$

and obtain a consistent quantization result. When the neural network is trained according to the quantized weight generated by the quantization procedure of the present disclosure, the training process is not affected by the weight distribution even in a small number of quantization bits.

Step P3 represents “training a quantization model”. Specifically, the processor performs a training procedure of the neural network model according to the quantized weight array. The training procedure may include a convolution operation and a classification operation of a fully-connected layer. In practice, when step P3 is performed by a deep learning accelerator proposed by the present disclosure, the following steps are performed: performing a multiply-accumulate operation by a processing element matrix according to the quantized weight array and an input vector to generate an output vector having a plurality of output values; detecting whether each of the plurality of output values is zero respectively by a detector array; reading the plurality of output values respectively by a readout circuit array; and when the detector array detects a zero output value, a reading unit of the readout circuit array corresponding to the zero output value is disable.

Step P4 represents “outputting a quantized weight array”. Specifically, the processor determines whether a loss function is convergent during the training procedure. When the loss function is convergent, the processor or the deep learning accelerator outputs a trained quantized weight array.

Table 1 below shows the prediction accuracy of the neural network models trained by the present disclosure and by a conventional quantization method, under two input datasets, Cifar-10 and human detect, together with different number of quantization bits. One tunnel represents a one-bit array, and the length of this one-bit array equals to the dimension of the channel.

TABLE 1

| Cifar-10 | Prior-art (fine-tuned) | Prior-art (without fine-tuned) | The present disclosure |
|---|---|---|---|
| 8w8a | 76% | 69% | 70% |
| 4w4a | 67% | 60% | 70% |
| Human detect | Prior-art (fine-tuned) | Prior-art (without fine-tuned) | The present disclosure |
| 8w8a | 93% | 92% | 98% |
| 4w4a | 94% | 83% | 94% |

As shown in Table 1, when the number of quantization bits is small, the present disclosure still has a high prediction accuracy, where 8w denotes a 8-bit weight and 8a denote a 8-bit model output value.

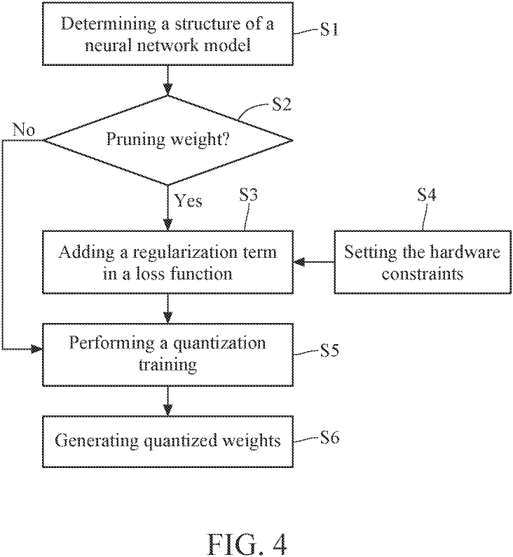

FIG. 4 is flow chart of a weight pruning method for the neural network model according to an embodiment of the present disclosure and includes steps S1–S6.

Step S1 represents “determining an architecture of a neural network model”. Specifically, according to the application field of the neural network model, the user can decide the architecture to be adopted by the neural network model in step S1. This model architecture includes various parameters, such as a dimension of an input layer, the number of quantization bits, and a size of a convolution kernel, the type of activation function or other hyper-parameters used for initialization, etc.

Step S2 represents whether to prune the weight. If the determination result of step S2 is “yes”, step S3 will be performed next. If the determination result of step S2 is “no”, step S5 will be performed next.

Step S3 represents “adding a regularization term in a loss function”. Step S4 represents “setting the hardware constraints”. Please refer to Equation 3 and Equation 4 below.

$$\text{E} \left(\text{W}\right) = {\text{E}}_{\text{D}} \left(\text{W}\right) + {λ}_{\text{s}} {\text{E}}_{\text{R}} \left(\text{W}\right)$$

where E(W) is a loss function with the regularization term being added, E_{D}(W) is a loss function, E_{R}(W) is the regularization term, λₛ denotes a weight of the regularization term E_{R}(W). The larger λₛ is, the greater the degree of regularization term E_{R}(W) becomes smaller in the convergence process of E(W).

$${\text{E}}_{\text{R}} \left(\text{W}\right) = E \left(W\right) = {E}_{D} \left(W\right) + {λ}_{s} ⋅ {\sum }_{l = 1}^{L} \left({\sum }_{{m}_{l}}^{{M}_{l}} {\sum }_{{k}_{l}}^{{K}_{l}} {\left‖{W}_{; , ; , {m}_{i} , {k}_{l}}^{\left(l\right)}\right‖}_{g}\right)$$

where L denotes the number of layers of the convolution computation, 1 (lowercase of L) denotes the current layer; M₁, K₁ denote height and width of the feature map respectively; m₁, k₁ denote the height and width in the current computation respectively; W⁽¹⁾ denotes the weight of the 1-th (lowercase of L) convolution operation; and g denotes the norm. In the hardware design, at least one of the above parameters correspond to the model architecture mentioned in step S1 and the hardware constraint mentioned in step S4. For example, M₁ and K₁ of the regularization term may be adjusted according to the kernel size. In other words, the hardware constraint mentioned in step S4 is a design requirement for specifying hardware, the Equation 4 is implemented only if the hardware constraint is determined.

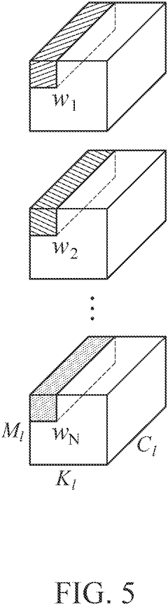

In order to make the meaning of each symbol in the regularization term E_{R}(W) easily to understand, please refer to FIG. 5, which illustrates a schematic diagram of the application of the weight when the convolution operation is performed at the 1-th layer (lowercase of L). The bit length of the weight is N, w₁, w₂, ..., w_{N} denote bits of this weight. As shown in FIG. 5, the length of the channel of the feature map is C₁, and each weight bits w₁, w₂, ..., w_{N} belong to a tunnel of length C₁ respectively.

During the train process of the model, the loss function added with the regularization term E_{R}(W) gradually converges, so that a plurality of weight values in the tunnel composed of weight bits tends to be zero, therefore the weight pruning effect is achieved. In other words, the loss function added with the regularization term E_{R}(W) can improve the sparsity of the model without decreasing the prediction accuracy of the model. The following Table 2 shows the accuracy, sparsity and tunnel sparsity of the neural network model adopting the original loss function (original model for short) and the neural network model adopting the loss function with the regularization term E_{R}(W) (pruned model for short), in two input datasets, Cifar-10 and human detect.

TABLE 2

| Cifar-10 | Accuracy | Sparsity | Tunnel sparsity |
|---|---|---|---|
| Original model | 0.69 | 1% | 0% |
| Pruned model | 0.68 | 54% | 25% |
| Human detect | Accuracy | Sparsity | Tunnel sparsity |
| Original model | 0.98 | 1% | 0% |
| Prune model | 0.91 | 70% | 19% |

In Table 2, the sparsity represents a ratio of the number of zero-value weights to the number of all weights in the model. The larger the sparsity, the more zero-value weights are. The tunnel sparsity represents that a ratio of the number of tunnels that all weights are zero to the number of total tunnels. Therefore, the tunnel sparsity also represents that how may computation can be saved in the hardware implementation. According to Table 2, while maintaining a certain accuracy, pruning the model can greatly improve the sparsity and tunnel sparsity, which helps to structurally simplify the hardware design and reduce hardware power consumption. The later paragraphs explain how to leverage the pruned model to achieve the software hardware collaboration by the deep learning accelerator proposed by the present disclosure.

To summarize steps S3 and S4: the loss function E(W) includes the basic term E_{D}(W), the weight values λₛ associated with the regularization term E_{R}(W), and the regularization term E_{R}(W). The basis term E_{D}(W) is associated with the quantized weight array, the regularization term E_{R}(W) is associated with a plurality of parameters of the architecture and the hardware constraint of the hardware architecture configured to perform the training process. The regularization term E_{R}(W) is configured to increase the sparsity of the post-trained quantized weight array. During the training procedure, determining whether the loss function E(W) is convergent includes: adjusting the weight values λₛ according to a convergence degree of basic term E_{D}(W) and the regularization term E_{R}(W). An example for the adjustment of weight values λₛ is as follows: decrease the weight values λₛ when the convergent degree of the regularization term E_{R}(W) is large, and increase the weight values λₛ when the convergent degree of the regularization term E_{R}(W) is small.

Please refer to FIG. 4. Step S5 represents “performing a quantization training”. Step S5 is basically identical to step P3 of FIG. 1. Before step S5 is performed, steps P1 and P2 of FIG. 2 have to be completed, i.e., performing the quantization procedure to generate the quantized weight array.

Step S6 represents “generating the quantized weight”. Step S6 is basically identical to step S4 of FIG. 1. After the loss function including the regularization term proposed by the present disclosure is convergent, values in the quantized weight array have been pruned (simplified). In other words, the regularization term mentioned in step S3 may improve the sparsity of the post-trained quantized weight array.

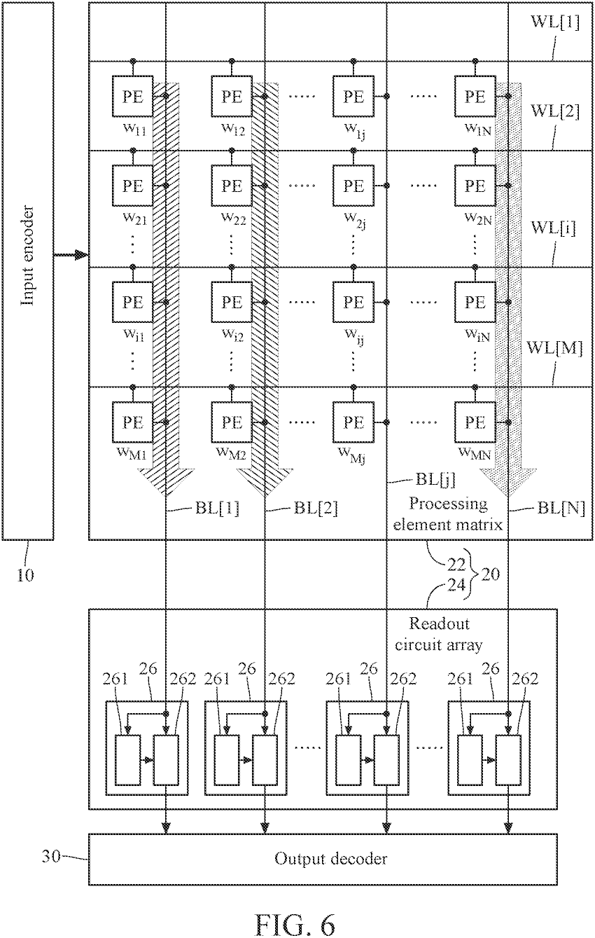

On the basis of the pruned quantized weight array described in previous paragraphs, the present disclosure proposes a deep learning accelerator. Please refer to FIG. 6, an architecture diagram of a deep learning accelerator according to an embodiment of the present disclosure. As shown in FIG. 6 the deep learning accelerator 20 electrically connects to an input encoder 10 and an output decoder 30. The input encoder 10 receives an N dimensional input vector X = [X₁ X₂ ... X_{N}]. The output decoder 30 is configured to output a M-dimensional output vector Y = [Y₁ Y₂ ... Y_{M}]. The present disclosure does not limit the values of M and N.

The deep learning accelerator 20 includes a processing element matrix 22 and a readout circuit array 24.

The processing element matrix 22 includes N bitlines BL[1]-BL[N], each bitline BL electrically connects M processing elements PE, and each processing element PE includes a memory device and a multiply accumulator (not depicted). The processing element PE is an analog circuit, and the multiply accumulator is implemented by a variable resistor. The plurality of memory devices of the plurality of processing elements PE of each bitline BL is configured to store a quantized weight array. The quantized weight array includes a plurality of quantized weight bits wᵢⱼ of the integer type, where 1≤i≤M and 1≤j≤N.

The processing element matrix 22 is configured to receive the input vector X, and perform a convolution operation to generate the output vector according to the input vector X and the quantized weight array. For example, the plurality of memory devices on bitline BL[1] stores the quantized weight bit array [w₁₁ w₂₁ ... w_{M1}], and the computation method of the bitline BL[1] is

$$\text{BL[1] =} {\sum }_{i = 1}^{M} {x}_{i} {w}_{i , 1} .$$

The readout circuit array 24 electrically connects to the processing element matrix 22, and include a plurality of bitline readout circuits 26. Each bitline readout circuit 26 correspond to each bitline BL, and includes an output detector 261 and an output readout circuit 262. The output detector 261 is configured to detect whether an output value at each bitline BL is zero, and disables the output readout circuit 262 corresponding to the bitline BL whose output value is zero. For example, when the output detector 261 detects that the current value (or voltage value) on the bitline BL[1] is zero, the output detector 261 disables the output readout circuit 262 corresponding to the bitline BL[1]. Therefore, the output value of the output readout circuit 262 corresponding to the bitline BL[1] may be also zero, so that Y₁ of the output vector is zero.

The deep learning accelerator 20 stores the aforementioned pruned quantized weight array in the plurality of memory devices of the processing element matrix 22. Since most of the bit values of this weight array are zero, the computation result can be obtained by the output detector 261 in advance, and thus the power consumption of the output readout circuit 262 may be reduced.

In view of the above, the present disclosure proposes a quantization method for a neural network model, this is a hardware-friendly quantization method, and the user may arbitrarily the number of quantization bits. The present disclosure further proposes a deep learning accelerator suitable to a DNN model with pruned weight values. Under the premise of maintaining the accuracy of the neural network model, the present disclosure uses the quantized weight and the output value to reduce the hardware computation cost, improve the hardware computation speed, and increase the fault tolerance of the hardware computation. The quantization method for a neural network model and the deep learning accelerator proposed in the present disclosure adopt software hardware collaboration design and have characteristics as follows:
1. Simplifying the quantization process without pre-training the quantization model;
2. Fixing the quantization interval by a nonlinear formula so that the quantization training is stable and accurate;
3. The user is allowed to arbitrarily set the number of quantization bits, the hardware design of bias term can be save according to the quantization model and the hardware proposed by the present disclosure;
4. The design collaborates the hardware computation detector and adds the structural regularization term to prune weight at the level of hardware architecture. During the training process, the plurality of weights of the tunnel is reduced to zero, and thereby improving the hardware computation speed;
5. The training of the neural network model including quantization and pruning process are performed in the software, the weight is of the floating-point type during the training, the weight is converted into the integer type after the training process is finished and is sent to the hardware for the prediction; and
6. The power consumptions of the bitline computation and the readout circuit array are saved and thus the overall computation power consumption is optimized.

Although the present disclosure is disclosed above with the aforementioned embodiments, it is not intended to limit the present disclosure. Changes and modifications made without departing from the spirit and scope of the present disclosure all belong to the patent protection of the present disclosure. For the scope of protection defined by the present disclosure, please refer to the attached claims.

What is claimed is:

1. A quantized method for a neural network model comprising:
initializing a weight array of the neural network model, wherein the weight array comprises a plurality of initial weights;
performing a quantization procedure to generate a quantized weight array according to the weight array, wherein the quantized weight array comprises a plurality of quantized weights, and the plurality of quantized weights is within a fixed range;
performing a training procedure of the neural network model according to the quantized weight array; and
determining whether a loss function is convergent in the training procedure, and outputting a trained quantized weight array when the loss function is convergent.

2. The method of claim 1, performing the quantization procedure to generate the quantized weight array according to the weight array comprising:
inputting the plurality of initial weights to a conversion function so as to convert an initial range of the plurality of initial weights into the fixed range; and
inputting a result outputted by the conversion function to a quantization function to generate the plurality of quantized weights.

3. The method of claim 2, wherein the conversion function comprises a nonlinear conversion formula, and the fixed range is [-1, +1].

4. The method of claim 3, wherein the nonlinear conversion formula is a hyperbolic tangent function.

5. The method of claim 3, further comprising determining an architecture of the neural network model, wherein:
the loss function comprises a basic term and a regularization term;
the basic term is associated with the quantized weight array;
the regularization term is associated with a plurality of parameters of the architecture and a hardware architecture configured to perform the training procedure; and
the regularization term is configured to increase sparsity of the quantized weight array after the training procedure.

6. The method of claim 5, wherein the loss function further comprises a weight value associated with the regularization term, and determining whether the loss function is convergent in the training procedure comprises adjusting the weight value according to a convergent degree of the basic term and the regularization term.

7. The method of claim 1, wherein performing the training procedure of the neural network model according to the quantized weight array comprises:
performing a multiply-accumulate operation by a processing element matrix according to the quantized weight array and an input vector to generate an output vector having a plurality of output values;
reading the plurality of output values respectively by a plurality of output readout circuits;
detecting whether each of the plurality of output values is zero by a respective one of a plurality of output detectors, and disabling an output readout circuit whose output value is zero from the plurality of output readout circuits, wherein the plurality of output detectors electrically connects to the plurality of output readout circuits respectively.

8. A deep learning accelerator comprising:
a processing element matrix comprising a plurality of bitlines, wherein each of the plurality of bitlines electrically connects to a respective one of a plurality of processing elements, each of the plurality of processing elements comprises a memory device and a multiply accumulator, the plurality of memory devices of the plurality of processing elements is configured to store a quantized weight array, the quantized weight array comprise a plurality of quantized weights; the processing element matrix is configured to receive an input vector, and perform a convolution operation to generate an output vector according to the input vector and the quantized weight array; and
a readout circuit array electrically connecting to the processing element matrix, and comprising a plurality of bitline readout circuits; the plurality of bitline readout circuits correspond to the plurality of bitlines respectively, each of the plurality of bitline readout circuits comprises an output detector and an output readout circuit, the plurality of output detectors is configured to detect whether an output value of each of the plurality of bitlines is zero, and to disable the output readout circuit whose output value is zero from the plurality of output readout circuits.
